(19) United States
(12) Patent Application Publication
(10) Pub. No.: US 2017/0148039 A1
(43) Pub. Date: May 25, 2017

(54) POWER MONITORING APPARATUS, A METHOD FOR POWER MONITORING AND A BASE STATION USED WITH THE AFOREMENTIONED

(71) Applicant: Singapore University of Technology and Design, Singapore (SG)

(72) Inventors: Erik WILHELM, Singapore (SG); Suranga NANAYAKKARA, Singapore (SG); Shaohui FOONG, Singapore (SG); Joseph FALVELLA, Singapore (SG); Don Samitha ELVITIGALA, Singapore (SG)

(21) Appl. No.: 15/313,946

(22) PCT Filed: May 25, 2015
(86) PCT No.: PCT/SG2015/050123

§ 371 Date: Nov. 23, 2016

(30) Foreign Application Priority Data
May 23, 2014 (SG) 102014026020Q

(51) Int. Cl. G06Q 30/02; G06Q 50/06; G05B 15/02; H02J 13/00

(52) U.S. Cl. CPC G06Q 30/0202; H02J 13/0017; G06Q 50/06; G05B 15/02; G06Q 30/0283

(57) ABSTRACT

There is provided a method of power monitoring comprising: determining the price for electricity for a user; determining the power consumption of an electrical appliance within the user's premises; and providing an output signal for the appliance to indicate to the user if the current operational mode of the appliance is desirable or undesirable to the user based on at least one of: the electricity price and the power consumption. An apparatus for power monitoring and a base station used in the method is also disclosed.

### CROSS REFERENCE TO RELATED APPLICATIONS

The present application is a filing under 35 U.S.C. 371 as the National Stage of International Application No. PCT/SG2015/050123, filed May 25, 2015, entitled “A POWER MONITORING APPARATUS, A METHOD FOR POWER MONITORING AND A BASE STATION USED WITH THE AFOREMENTIONED,” which claims the benefit of and priority to Singapore Application No. 10201402602Q, filed with the Intellectual Property Office of Singapore on May 23, 2014, both of which are incorporated herein by reference in their entirety for all purposes.

### FIELD OF INVENTION

The present invention relates to a power monitoring apparatus, a method for power monitoring and a base station used with the aforementioned.

### BACKGROUND

The term “smart grid” generally describes a family of technologies which will enable better/optimal matching of generation supply with end-use demand of electrical utilities. These technologies relate to, for example, demand response, load balancing, grid improvement measures and so forth.

Currently, there has been limited long-term adoption of smart grid technology, despite significant penetration of smart sensor meter units. A significant issue causing a lack of traction for consumer-facing smart grid technology can be attributed to the way that consumer price signals are communicated to users. Currently, the users receive the requisite information via, for example, a web portal, an application on a mobile device, text/email, bill statements in the post and so forth. The delays caused by the communication methods minimises the influence the consumer price signals have on consumer behaviour. This has resulted in poor knowledge in relation to “smart grids” by the consumers, thus adversely affecting widespread installation of sensors in particular markets and enhancements in the “smart grid” industry.

Existing systems such as, for example, Owl Home Monitor, Onzo, CI-Amp, Eyedro and the like, are unable to provide timely decision-influencing “spot pricing” feedback which is essential for optimising smart grids.

Thus, there are issues which need to be addressed which will improve the adoption of “smart grids”.

### SUMMARY

In a first aspect, there is provided a method of power monitoring comprising: determining the price for electricity for a user; determining the power consumption of an electrical appliance within the user's premises; and providing an output signal for the appliance to indicate to the user if the current operational mode of the appliance is desirable or undesirable to the user based on at least one of: the electricity price and the power consumption.

It is preferable that the price and power consumption is updated either periodically or in real-time.

Preferably, the output signal is provided either adjacent to the appliance or at a base station. The output signal may also based on the type of appliance, the time, stored data on the user, prior usage patterns of the appliance, and whether the output signal is visible to the user. The output signal may be dependent on a thin-layer neural network model and can be provided instantaneously.

In a second aspect, there is provided an apparatus for power monitoring comprising: a non-contact current sensor configured to determine the power consumption of an appliance, a transmission module configured to receive electricity price data, and an output module configured to provide a user with an indication if the current operational mode of the appliance is desirable or undesirable to the user based on at least one of: the electricity price and the power consumption. The apparatus may further include a flexible substrate configured to support the apparatus.

Preferably, the non-contact current sensor includes an array of anisotropic magnetoresistance (AMR) elements in a spaced apart configuration.

The apparatus can be either cable-mounted or is incorporated within a glove. The apparatus may also be configured to operate in a plurality of states and the indication provided by the output module can be at least one type such as, for example, visual, audio, tactile and so forth.

In a third aspect, there is provided a base station for a plurality of power monitoring apparatus comprising: a modem configured to connect to a remote server, and to access real-time electricity pricing data; a wireless network module configured to wirelessly communicate with the plurality of apparatus; and an output module configured to provide output indications for any of the plurality of apparatus. The base station can be configured to operate in a plurality of states.

### DESCRIPTION OF THE FIGURES

In order that the present invention may be fully understood and readily put into practical effect, there shall now be described by way of non-limitative example only preferred embodiments of the present invention, the description being with reference to the accompanying illustrative figures.

FIG. 1 shows a system for power monitoring of the present invention.

FIG. 2 shows a schematic diagram of a power monitoring apparatus of the present invention.

FIG. 3 shows a block diagram of a base station of the present invention.

FIG. 4 show firmware algorithmic flow charts for the apparatus sensors in various states.

FIG. 5 show base station algorithmic flow charts in various states.

FIG. 6 shows the device signal processing algorithm flow chart.

FIG. 7 shows circuit diagrams for various embodiments for the apparatus of FIG. 2.

FIGS. 8(a)-8(c) show illustrative examples for apparatus placement.

FIG. 9 shows an illustrative example of a room equipped with the apparatus.

FIG. 10 shows an illustrative example of a home equipped with the apparatus.

FIG. 11 shows a process flow for a method of power monitoring of the present invention

FIG. 12 shows the apparatus integrated into a work glove.

FIG. 13 shows a photograph of a test apparatus used to test the apparatus, consisting of resistive and inductive loads.

FIG. 14 shows cross sectional views of the test cable of the test apparatus at various positions.

FIG. 15 shows a linear regression model fit showing limited error of up to 1.2 kW of resistive load.

FIG. 16 shows error in current measurement at various positions using the linear regression model.

### DESCRIPTION OF PREFERRED EMBODIMENTS

Referring to FIG. 2, there is provided an apparatus 20 for power monitoring at least one appliance. The apparatus 20 is designed to be simple, low cost and is configured to be installed by users with minimal difficulty. The apparatus 20 may be in a form of a roll or on a flat surface and can be removably attached to a cable of an appliance. The apparatus 20 comprises a non-contact current sensor 22 configured to determine power consumption of the at least one appliance, a transmission module 24 configured to receive electricity price data, and an output module 26 configured to provide a user with an indication if the current operational mode of the at least one appliance is favourable or unfavourable to the user based on the electricity price data and the power consumption.

The non-contact current sensors 22 include an array of anisotropic magnetoresistance (AMR) elements which are configured in a manner to collect information pertaining to power consumption of the appliance. For example, the array includes four AMR elements mounted on the apparatus 20 in a manner where the elements are spaced apart from each other when the apparatus 20 is mounted to the cable. The elements can be equidistant from each other or arbitrarily spaced. The AMR elements are connected to a common power supply, and a common I2C bus for communicating the data that they are generating. An AMR element typically consists of multiple strips of permalloy (80% Ni and 20% Fe) connected together in a serpentine pattern. Current shunts force the current to flow through the permalloy at 45° to a first axis along a surface which the AMR element is mounted to. During fabrication of the AMR element, a magnetic field is applied along the strip's length to magnetize it and establish the first axis. A current is passed through the film at 45° to the first axis. A magnetic field is applied at right angles to a magnetization vector along the first axis which causes the magnetization vector to rotate and the magnetoresistance to change. The array of AMR elements are mounted either on a flexible PCB or on hinged surfaces which allow users to mount the apparatus 20 in a desired manner.

The transmission module 24 can be a low-bandwidth, low cost radio transmitter (e.g. a Zigbee transceiver). The transmission module 24 is configured to relay aggregated power consumption information to a base station.

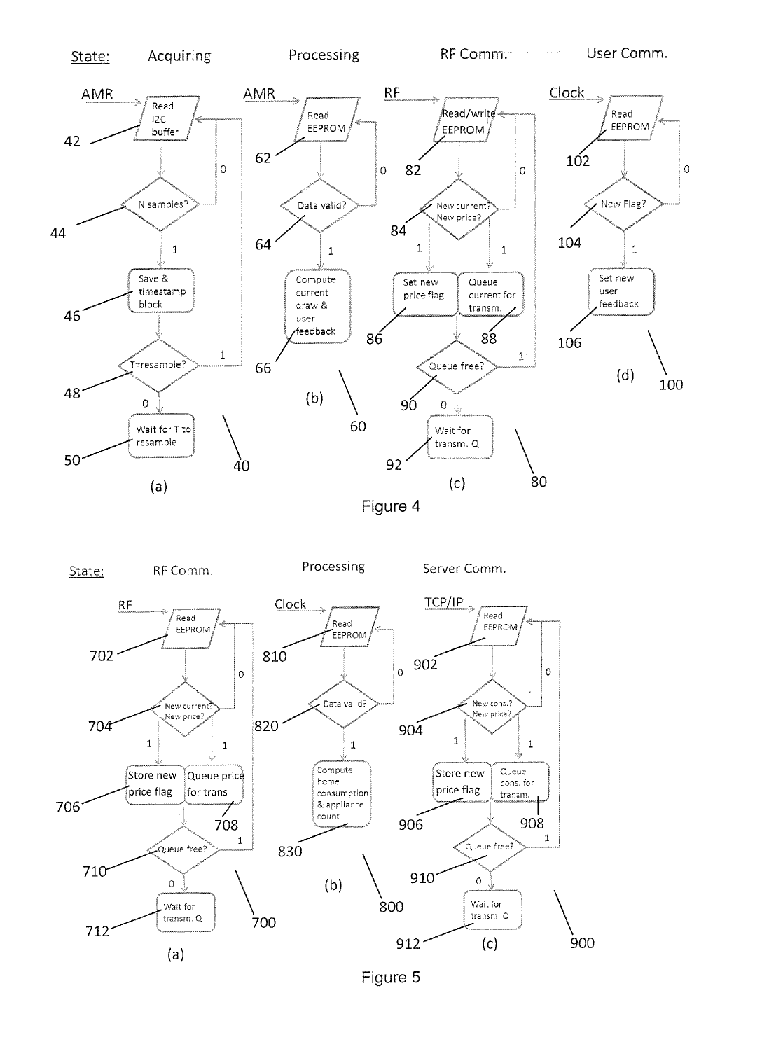

In addition, the apparatus 20 can also include a low cost 8-bit microprocessor 28 for data storage and for running of the apparatus 20 while using proprietary firmware. The microprocessor 28 also controls the transmission module 24 and arbitrates when the apparatus 20 should sleep, take data, and communicate with the base station. Main algorithms running on the 8-bit microcontroller for each apparatus 20 are shown in FIG. 4.

FIG. 4(a) shows a first process 40 during an “acquiring” state of the microprocessor 28. In the first process 40, information obtained from the AMR elements are input to the I2C buffer (42), with a predetermined number of information, N being collected (44), and once N is collected, the block of N numbers of information is saved and time-stamped (46). Subsequently, a wait (50) of a predetermined time, T (48) before the first process 40 is repeated.

FIG. 4(b) shows a second process 60 during a “processing” state of the microprocessor 28. In the second process 60, information obtained from the AMR elements are input to the EEPROM of the microprocessor 28 (62), and if the information is valid (64), the power consumption of the appliance at that juncture is determined and the user is informed accordingly (66).

FIG. 4(c) shows a third process 80 during an “RF comms” state of the microprocessor 28. Data transmission via RF communications is carried out in a distributed ad-hoc mesh network configuration. Electricity spot price data is written to non-volatile EEPROM of the microprocessor 28 (82). New price levels or new identified current levels read from the EEPROM (84) triggers a new price flag (86) and queues for a free transmission window (88). Once the transmit buffer is free (90), current consumption data is sent back to the base station via RF, otherwise the device waits for a free transmission window (92).

FIG. 4(d) shows a fourth process 100 during a “user comms” state of the microprocessor 28. After a predetermined time, the EEPROM of the microprocessor 28 is read (102) and it is determined whether a new indication should be provided to the user (104). If so, the new indication is provided (106).

As shown in FIG. 4, some of the main algorithms running are to process the individual and independent magnetic flux density measurements from each AMR element and estimate in real-time the current flowing in the appliance (specifically at the attached cable producing a measurable magnetic field). The AMR elements are configured to accurately identify current without calibration and without requiring much microprocessor processing in order to allow the apparatus 20 to operate for more than two years on one coin cell. Several states are not shown in FIG. 4, including the automatic identification of hard-to-see nodes, the identification of load type (to classify as a fan, air conditioner and the like) and the automatic registration and de-registration of nodes. They are not shown in FIG. 4 because they simply consist of periodically checking if light sensor thresholds correspond to daylight periods in the time zones where the apparatus 20 are in use, or alternatively checking if current has been sensed periodically to decide whether to register or deregister with the base station.

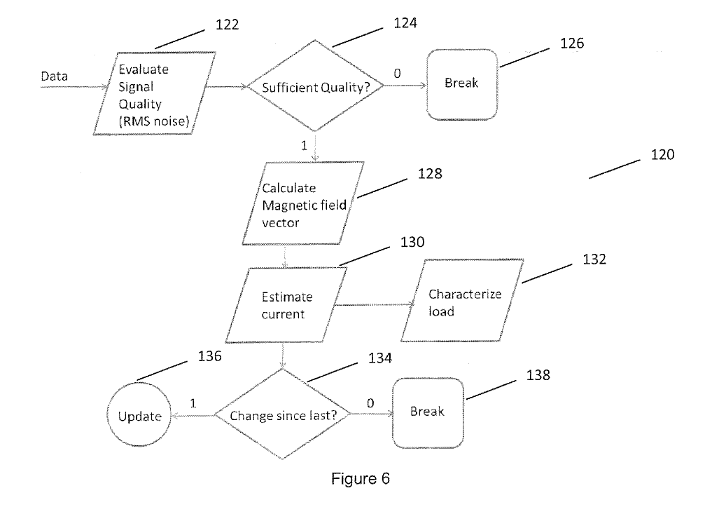

A signal processing algorithm 120 used on the apparatus 20 is shown in FIG. 6. Generally, the algorithm 120 is configured to function with minimal data processing resources while providing accuracy above a predefined threshold. Firstly, signal quality is evaluated (122), and quality of the signal is determined (124). Signal quality deemed of unacceptable quality (126) is used to cause the apparatus 20 to enter a dormant state(s), and not used in the current identification algorithm. When the signal quality is acceptable, magnetic field vector is calculated (128). The algorithm 120 leverages on the relationship between the distance of a current-carrying conductor and its magnetic field according to the Biot-Savart law to deduce the likely current (130) and characterise the load (132) without the need for any calibration. If the current has changed (134), the value of the current is updated (136) and if not, then the apparatus 20 enters a dormant state(s) (138).

In one embodiment, the output module 26 is an array of RGB LEDs configured to provide visual feedback. For example, if the apparatus 20 has determined that the appliance it is attached to is a heavy consumer of power compared to an appliance which has shown lower power consumption over an extended duration of time, the red LED will light up to indicate ‘use appliance only if necessary’. In addition, the green LED will light up to indicate a ‘low usage constraint’ type of appliance while the blue LED is for indicating an arbitrary middle ground. The output module 26 can also be an OLED/LCD panel or a combination of RGB LEDs and an OLED/LCD panel. Alternatively, the output module 26 can also be/include audio signal generators and/or tactile feedback actuators.

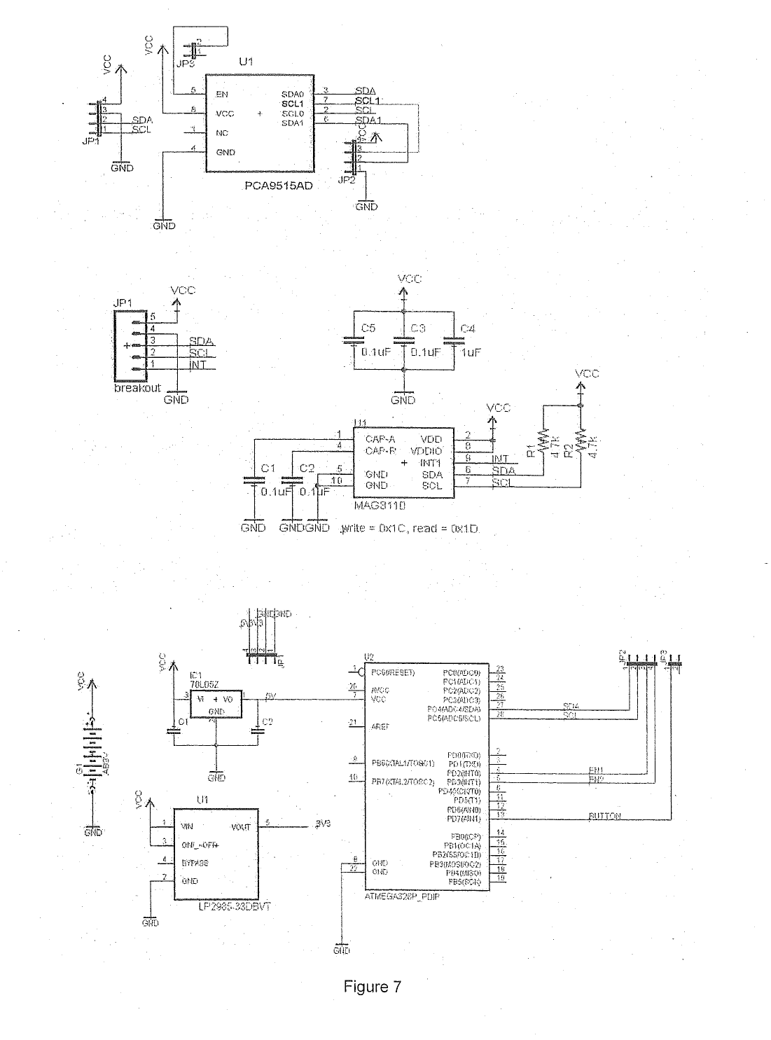

Three embodiments of the apparatus 20 as shown using circuit diagrams are shown in FIG. 7.

In order to use the apparatus 20, installation is simple, and no calibration is required. After installation, the apparatus 20 automatically begins to measure current using models based on Ampere's current law and the Biot-Savart law. Instantaneous (or after a slight time lag) feedback is provided to the user once the characteristic frequencies of the appliance being monitored are determined. Information received from the base station at the apparatus 20 is used to define usage recommendations which a user receives.

Should the apparatus 20 be removed from the wire, they will automatically enter a dormant state to conserve battery life until they are mounted to another wire. They will then determine the load characteristics of the cable which they are attached to, in order to accurately identify current. Any physical adhesives used with the apparatus 20 should be usable for several re-mountings. The apparatus 20 will also indicate when low battery conditions exist.

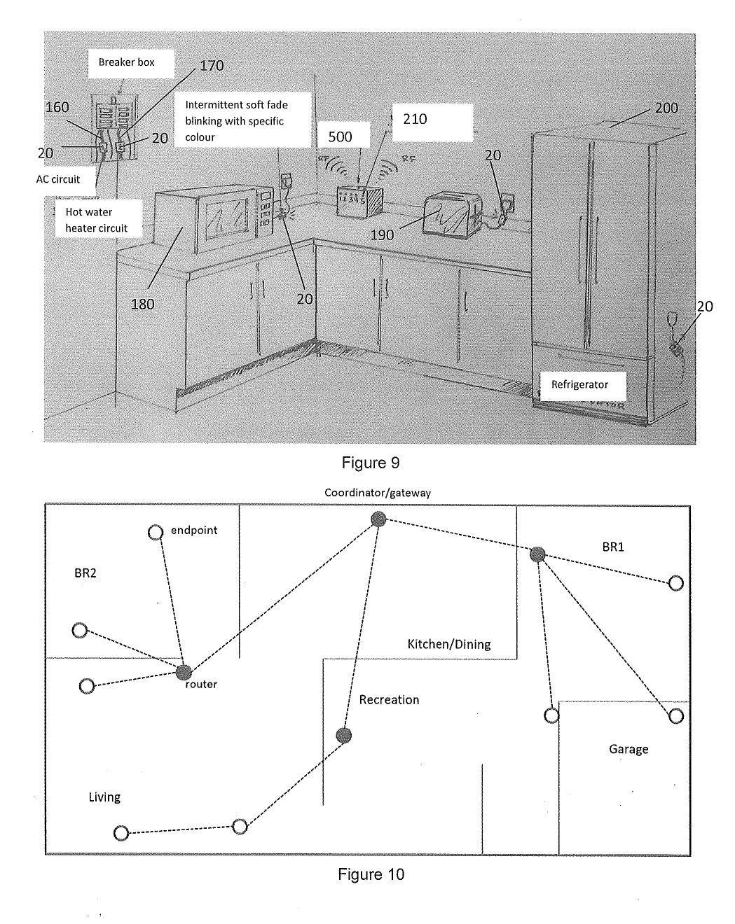

The apparatus 20 are configured to self-indicate if they are not visible by users by using a light sensor. If the light sensor is activated (when detected light falls below a predetermined threshold), the apparatus 20 transmits a sequence of audible indicators corresponding to an associated LED indicated at the base station. Users can then label the associated LED on the base station so as to be able to monitor appliances for which the cable is not easily seen/accessible. If the self-indication of hard-to-see apparatus 20 is unsuccessful, users can use a web/app interface to manually specify that an apparatus 20 should be indicated at the base station. FIG. 9 shows a typical scenario when the apparatus 20 is deployed in a kitchen. The visible apparatus 20 is mounted to wires of an air conditioning system 160, a water heater 170, a microwave oven 180, a toaster 190, and a refrigerator 200. The base station 210 is shown, with LEDs to indicate the apparatus 20 which are not visible to the user. Further information on the base station 210 will be provided in later paragraphs. FIG. 9 is representative of any room which is indicated in FIG. 10.

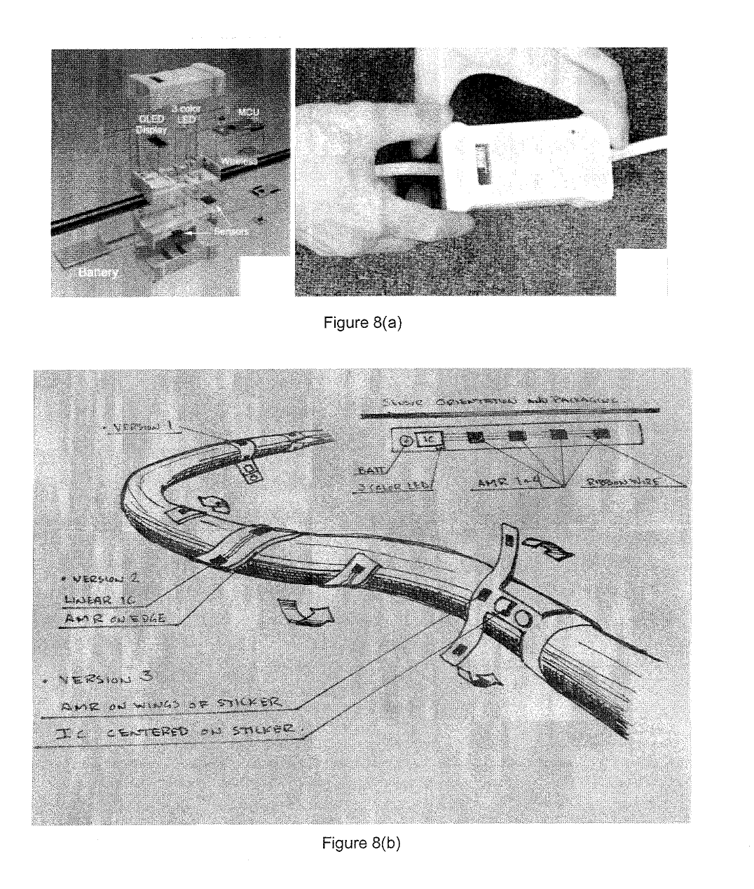

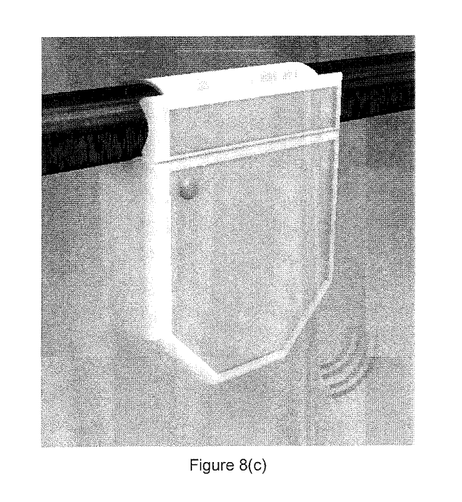

Various embodiments of the apparatus 20 are shown in FIGS. 8 and 12. The various embodiments are mounted differently to cables. FIG. 8(a) shows an embodiment of the apparatus 20 which is clamped to the cable. It is used for proof of concept purposes.

FIG. 8(b) shows two embodiments. The first embodiment 300 of the apparatus 20 is where the microprocessor 28 and the non-contact sensors 22 are configured in a series arrangement, while the second embodiment 400 of the apparatus 20 includes a substrate with a central stem 402 (where the microprocessor 28 is mounted) and a plurality of wings (where the non-contact sensors 22 are mounted). The first embodiment 300 is best suited to applications in constrained spaces like circuit breaker boxes or where cables are moved frequently (for example, hand blenders, hair dryers, mobile device charging cables and so forth). The second embodiment 400 is best applied for stationary, exposed cables. FIG. 8(c) shows another embodiment of the apparatus 20 which is also clamped to the cable. FIG. 12 shows the apparatus 20 integrated into a work glove, whereby the work glove enables factory workers to check the load of a 3-phase appliance in real-time.

Thus, for the sake of illustration, use instances for the apparatus 20 could include:

(a) high spot prices:
strongly discourage use for high consumption appliances;
moderate discouragement of use for low consumption appliances;
strongly discourage use for appliances identified as less-critical types;

(b) low spot prices:
moderate or no discouragement of use for high consumption or less-critical appliances;

(c) in all instances:
hidden apparatus 20 use audio signals at the point of attachment to warn against use (high consumption or less-critical appliances) as well as providing visual indications against use at the base station;
apparatus 20 which are visible on the cable provide visible and/or haptic indications;
at least moderate discouragement of use for high consumption or less-critical appliances; and
no discouragement of use for low consumption or critical appliances.

It should be noted that the apparatus 20 is a “mount-and-use” device which does not require any configuration or renovation of premises. It is convenient for users.

Referring to FIG. 3, there is provided a base station 500 for a plurality of power monitoring apparatus 20. The base station 500 functions as a gate-way between the apparatus 20, and a remote server(s). The base station 500 was referred to earlier in the description. The base station 500 comprises a modem 502 configured to connect to a remote server(s) (where the data is anonymously stored), and to access real-time electricity pricing data. The modem 502 can be a wireless transceiver using Wi-Fi communication protocols (for example, using a Wi-Fi 2.4 GHz chipset). The base station 500 communicates via TCP/IP to the remote server(s) which aggregates electricity spot prices from utilities providers using various public APIs, and receives aggregated consumption data for each apparatus 20 asynchronously. This data is anonymous, but is registered to a particular part of the grid, the relevance of which is set by the grid operator/provider of the apparatus 20. By processing the vast majority of the data locally at the apparatus 20, most privacy issues are alleviated. Aggregated variables are sent using proprietary data formats creating a layer of privacy and security through obfuscation, above and beyond standard ZigBee data encryption protocols.

The base station 500 also includes a wireless network module 504 configured to wirelessly communicate with the plurality of apparatus 20 (in a distributed ad hoc mesh network). The wireless network module 504 can be an RF transceiver (for example, a transceiver capable of communicating on a proprietary radio protocol at 2.4 GHz like Zigbee, Bluetooth, IEEE 801.15.1, IEEE 802.15.4 and the like). Any one of the apparatus 20 can act as a repeater, passing data amongst each other to the base station 500 in a mesh-network arrangement. The mesh networking protocol is proprietary as it requires the apparatus 20 with significant sleep time to still be able to pass on data. FIG. 10 shows how the mesh network may be built in a typical home, with data being passed between the apparatus 20 to the base station 500. The activation of the apparatus 20 and its registration with the base station 500 can happen autonomously, without user input, once current flow in the cable with the apparatus 20 is mounted to is detected.

The base station 500 also includes an output module 506 configured to provide output indications for any of the plurality of apparatus 20 that are not visible to the user. The output module 506 can be, for example, RGB LEDs, speakers, haptic feedback generators and so forth. The user can either confirm that a hidden apparatus 20 which is beeping with a pattern by pressing a button on the base station 500 to confirm the signalling apparatus 20 corresponds to an associated base station indicator; or the user can manually configure the name/location of the apparatus 20 using the web/app interface.

The firmware on the apparatus 20 and the base-station 500 is developed in C on an 8 bit Atmel processor. But it can be adapted to work on any microcontroller/microprocessor. The minimum hardware requirement is an 8 bit microcontroller with standard set of peripherals such as I/O ports, ADC, communication ports (UART, I2C, SPI).

The base station 500 also includes an 8 bit processor 510 which requires continuous power 508, and should be located close to a wireless router. The base station 500 does not perform significant data processing. The various states which the base station 500 can be in are shown in FIG. 5, but does not include the additional steps for registering/deregistering of apparatus 20, scanning for unusual consumption patterns to signify malfunction or safety hazard (broken fridge compressor or sharply increasing consumption) and automatically or manually configuring feedback for hidden apparatus 20.

FIG. 5(a) shows a first process 700 during an “RF comms” state of the base station 500. Data transmission via RF communications is carried out in a distributed ad-hoc mesh network configuration. Electricity spot price data is written to non-volatile EEPROM of the processor 510 (702). New price levels or new identified current levels read from the EEPROM (704) triggers storing of a new price flag (706) and queues for a free transmission window (708). Once the transmit buffer is free (710), current consumption data is sent back to the apparatus 20 via the RF module 504, otherwise the base station 500 waits for a free transmission window (712).

FIG. 5(b) shows a second process 800 during a “processing” state of the base station 500. In the second process 800, after a predetermined time, the EEPROM of the processor 510 is read (810) and it is determined whether data from the apparatus 20 is valid (820). If so, the total consumption and appliance count is provided to the remote server. (830).

FIG. 5(c) shows a third process 900 during a “server comms” state of the base station 500 when acquiring price data from the remote server. Data transmission via the modem 502 is carried out in a distributed ad-hoc mesh network configuration. Electricity spot price data is written to non-volatile EEPROM of the processor 510 (902). New price levels or new identified current levels read from the EEPROM (904) triggers storing of a new price flag (906) and queues for a free transmission window (908). Once the transmit buffer is free (910), current consumption data is sent back to the remote server via the modem 502, otherwise the base station 500 waits for a free transmission window (912).

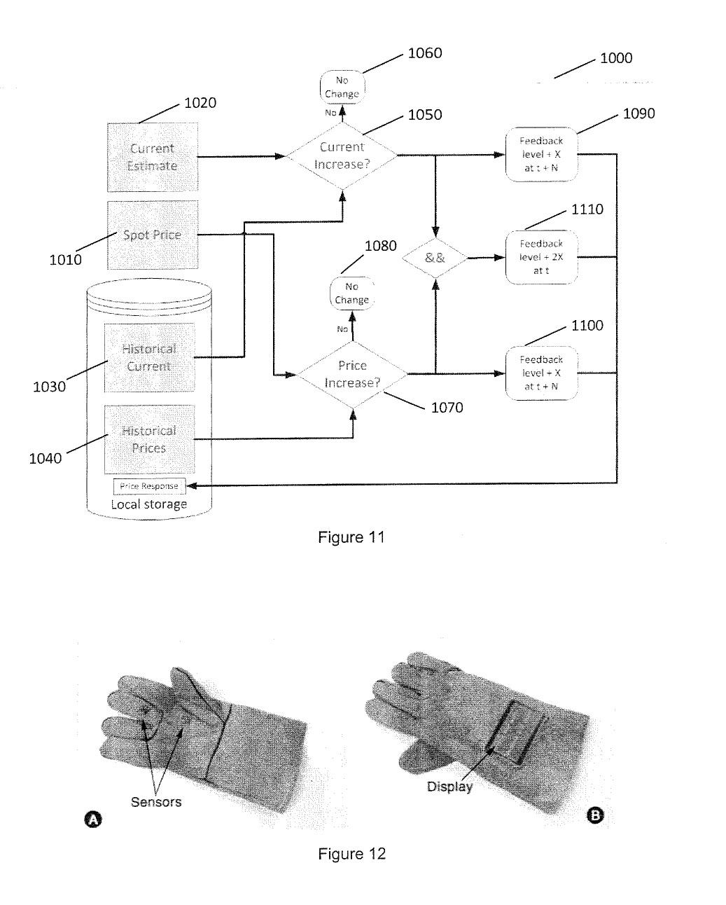

Referring to FIG. 11, there is shown a method 1000 of power monitoring. The method 1000 involves use of a “mount-and-use” apparatus 20 so is convenient for users. The method 1000 comprises determining the price for electricity for a user (1010), determining the power consumption of an electrical appliance within the user's premises (1020). Historical power consumption levels (1030) and historical as well as present electricity prices (1040) are also obtained. If it is determined that there is no change in power consumption (1050), then the user will not be informed of any need to change (1060). Similarly, if it is determined that there is no change in price (1070), then the user will not be informed of any need to change (1080). If there are changes in either power consumption or price, changes in consumption or price are used to determine which factor should be used to set a new feedback level (1090, 1100). For example, five or fewer feedback levels are defined, however some markets may require higher or lower resolution in providing feedback. Next, the time offset is determined for which the feedback should be provided. If both the price and consumption increases, immediate (or after a slight time lag) feedback is given (1110). If one or the other rose, then there is a delay of N seconds in returning consumer feedback. The level of feedback also depends on the patterns of behaviour observed during previous measurement and feedback cycles to determine the factor X. This factor is learned through training a known adaptable thin-layer neural network model to promote overall lower cost.

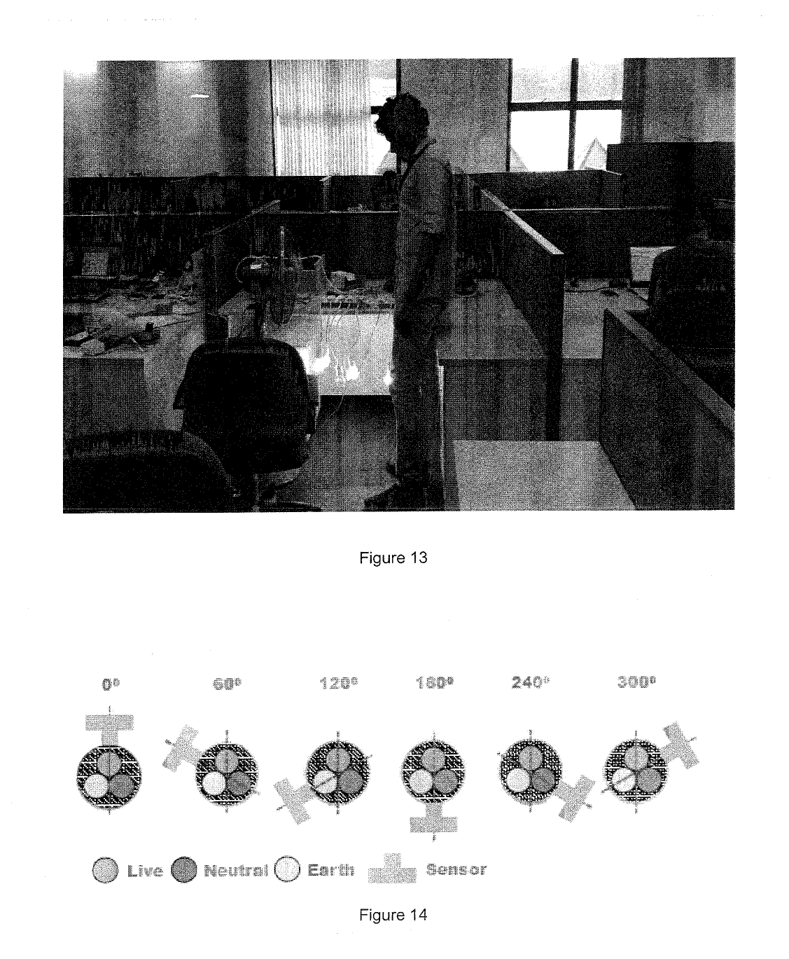

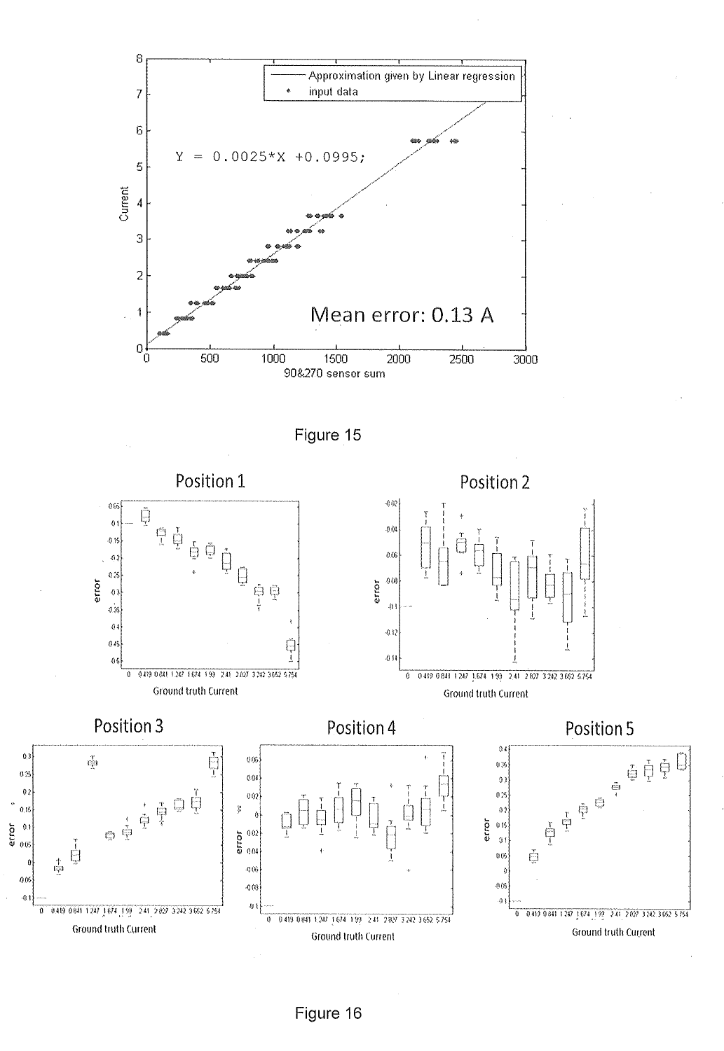

Initial proof of concept work has been performed, and it has been ascertained that the underlying principles and technologies are sound and workable. Referring to FIG. 13, a test apparatus consisting of nine one-hundred watt bulbs and one five-hundred watt bulb as resistive loads is shown. Tests have also been performed with inductive loads from an electric fan, also shown in FIG. 13. The tests were performed by holding sensors (representing apparatus 20) in a cut plastic jig a pre-determined distance from the cable in various angular orientations. Ground truth was measured using a standard semi-invasive hall-effect sensor as shown in FIG. 14. A simple linear regression model for early testing was fitted to the data from the angular sensor orientations with the maximum SSE of the xyz sensor measurement shown in FIG. 15. Minimal aggregate error is indicated. The error observed at the various measurement positions for the linear regression model in FIG. 16 displays the expected variation dependent on where the measurements were taken. Further assessment during the proof of concept work has led to the implementation neural-network based learning as described earlier.

The apparatus 20, base station 200 and method 1000 can be implemented in regions/provinces/countries where time-of-use utilities pricing has been implemented. Notable markets are those in Singapore (currently for large consumers only), California, Ontario, and several Northern US states. This system works especially well in markets where there are low levels of spinning reserves, and/or the base load is covered by technologies such as nuclear or hydro with limited variable capacities.

In addition, the apparatus 20, base station 200 and method 1000 will also be useful for industrial applications where monitoring three-phase power is necessary. In such applications, the apparatus 20 would be useful for the following:
determining power consumption patterns of processes which are at risk of failure;
evaluating overall energy efficiency of a facility; and
spot-checking process loads.

Based on the aforementioned paragraphs, it should be appreciated that there are many advantages brought about from use of the apparatus 20, the base station 500 and the method 1000. The apparatus 20, the base station 500 and the method 1000 belong to a class of products and systems-level technologies which are described as enabling the ‘smart-grid’. The advantages include:

i. self-registration and activation (and, if necessary, re-activation and registration) of the apparatus 20 which occurs autonomously;

ii. automatic identification of the apparatus 20 which are not easily seen, and relaying of usage recommendations for these apparatus 20 via non-visual cues or through the base station 500;

iii. provision of indicators to users to influence their decisions regarding appliance use at the point of use, that is, does not require logging in to a web/app interface, or checking a centralized screen;

iv. rely on signal processing and machine learning algorithms developed to merge historical consumption data with real-time price signals to provide real-time feedback to users;

v. do not require calibration to provide relatively accurate and useful data;

vi. do not encounter privacy issues as all information is processed locally;

vii. no need for wires and no battery life issues as communication is via a proprietary wireless mesh network;

viii. continual updating of firmware can be carried out on-the-fly to respond to fluctuations in bus voltages; and

ix. fool-proof usability due to use of flexible PCB technology to enable reliable user installation with low installation error.

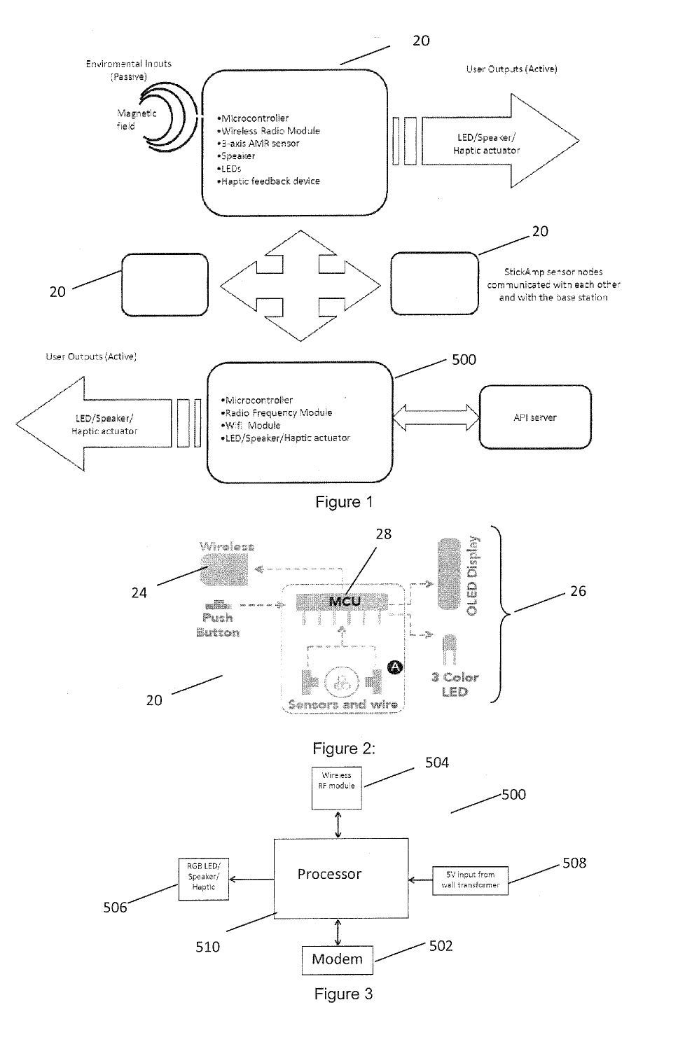

The apparatus 20, the base station 500 and the method 1000 are suitable for providing useful user feedback to enable more cost-conscious use of electricity in markets where time-of-use tariffs apply. They will not, however, enabling load balancing. It is expected that an absolute accuracy of 10% can be achieved, which will be sufficient to control demand through price signals in a demand-response scheme. Thus, energy and cost for the users can be saved through intelligent decision making. FIG. 1 shows a simplistic overview of the interaction between the apparatus 20, and the base station 500, and this interaction would enable the method 1000.

Whilst there have been described in the foregoing description preferred embodiments of the present invention, it will be understood by those skilled in the technology concerned that many variations or modifications in details of design or construction may be made without departing from the present invention.

1. A method of power monitoring comprising:
determining the price for electricity for a user;
determining the power consumption of an electrical appliance within the user's premises; and
providing an output signal for the appliance to indicate to the user if the current operational mode of the appliance is desirable or undesirable to the user based on at least one of: the electricity price and the power consumption.

2. The method of claim 1 wherein the price is updated periodically.

3. The method of claim 1 wherein the price is updated in real-time.

4. The method of claim 1, wherein the power consumption is updated periodically.

5. The method of claim 1, wherein the power consumption is updated in real time.

6. The method of claim 1, wherein the output signal is provided adjacent to the appliance.

7. The method of claim 1, wherein the output signal is provided at a base station.

8. The method of claim 1, wherein the output signal is also based on the type of appliance, the time, stored data on the user, prior usage patterns of the appliance, and whether the output signal is visible to the user.

9. The method of claim 1, wherein the output signal is dependent on a thin-layer neural network model.

10. The method of claim 1, wherein the output signal is provided instantaneously.

11. An apparatus for power monitoring comprising:
a non-contact current sensor configured to determine the power consumption of an appliance,
a transmission module configured to receive electricity price data, and
an output module configured to provide a user with an indication if the current operational mode of the appliance is desirable or undesirable to the user based on at least one of: the electricity price and the power consumption.

12. The apparatus of claim 11, wherein the non-contact current sensor includes an array of anisotropic magnetoresistance (AMR) elements in a spaced apart configuration.

13. The apparatus of claim 11, further including a flexible substrate configured to support the apparatus.

14. The apparatus of any of claims 11 to 13, wherein the apparatus is cable-mounted.

15. The apparatus of claim 11, wherein the apparatus is incorporated within a glove.

16. The apparatus of claim 11, being configured to operate in a plurality of states.

17. The apparatus of claim 11, wherein the indication provided by the output module is at least one type selected from a group consisting of: visual, audio and tactile.

18. A base station for a plurality of power monitoring apparatus comprising:
a modem configured to connect to a remote server, and to access real-time electricity pricing data;
a wireless network module configured to wirelessly communicate with the plurality of apparatus; and
an output module configured to provide output indications for any of the plurality of apparatus.

19. The base station of claim 18, being configured to operate in a plurality of states.
